(19) United States
(12) Patent Application Publication
(10) Pub. No.: US 2002/0159146 A1
(43) Pub. Date: Oct. 31, 2002

(54) Apparatus and process for changing the illumination power in a microscope

(75) Inventors: Volker Leimbach, Ludwigshafen (DE); Heinrich Ulrich, Heidelberg (DE)

Correspondence Address: SIMPSON & SIMPSON, PLLC, 5555 MAIN STREET, WILLIAMSVILLE, NY, 14221-5406, US

(73) Assignee: Leica Microsystems Heidelberg GmbH, Mannheim (DE)

(21) Appl. No.: 10/133,774

(22) Filed: Apr. 26, 2002

(30) Foreign Application Priority Data
Apr. 26, 2001 (DE) DE 10120422.1-42
Jan. 18, 2002 (DE) DE 10201870.7-51

(51) Int. Cl. G02B 26/02

(52) U.S. Cl. 359/388; 359/232; 359/305; 359/368

(57) ABSTRACT

To weaken the light beam (12) in a microscope (100), especially in a scanning microscope, we propose an apparatus for the variable change of the illumination power that is arranged so that a light beam of zero diffraction order (17) emanating from a modulator (13) can be used directly for the purposes of microscopy. The acusto optical modulator (13) is the only element in the microscope influencing the power of light in a variable way.

### CROSS REFERENCE TO RELATED APPLICATIONS

This application claims priority of the German patent applications 101 20 422.1-42 and 102 01 870.7-51 which are incorporated by reference herein.

### FIELD OF THE INVENTION

The invention refers to an apparatus for changing the illumination power in a microscope.

Furthermore, the invention refers to a process for changing of the illumination power in a microscope.

### BACKGROUND OF THE INVENTION

When investigating samples with the help of microscopes and especially when investigating them with the help of confocal scanning microscopy, it is necessary to reduce the light beams emanating from the source of illumination with regard to their illumination power. This is also true for many other optical apparatus. In doing so, it is preferable to design the degree of reduction in a variable way and to adapt it to the corresponding needs.

Devices for the reducing of the illumination emanating from a light source are known through the multi-photon-microscopy (MP-microscopy). During this process the object to be investigated is scanned by a light beam and the corresponding excited fluorescence illumination is examined. An electro-optical modulator (EOM) can be used to reduce the light beam emanating from the light source. To do so, a double-diffracting crystal is used the characteristics of which are dependent on the high voltage applied to the crystal. This electro-optical effect can be used to modify the illumination power by changing the degree of high voltage. It is all the more possible to change the direction of polarization of the illumination spreading within the crystal according to the high voltage power in order to adjust the variation of the illumination power with a downstream analyzer. When used in microscopes, however, components like that bear the disadvantage that they require high voltage and that they can be realized geometrically only comparatively large.

Furthermore, in confocal scanning microscopy it is well known practice, e.g. as shown in the U.S. Pat. No. 6,038,067, to use filters that are arranged on a rotating disc. The filters are meant to limit the beam. In addition this document suggests to use mirrors powered by galvanic-metrics and acusto optical beam-control units or a micro lense array. When using an acusto optical modulator (AOM), to a medium, which is transparent to the impinging light beam, a high frequency vibration is applied. When using laser light, quartz glass for example, can be used in the visible or UV-range as a medium. TeO₂, for example, can be utilized for short infrared wavelengths. Within the medium the high frequency vibration causes a grating, which diffracts the incident illumination. This leads to a modulation of the light power of the incident laser light, which can be modified via the angle of incidence of the light and the frequency of vibration. Although especially the acusto optical beam-controlling units are very flexible, they can only ensure a sufficient weakening of the beam, if for the use in a microscope light beams of the first diffraction order are further used. Using the first diffraction order bears however the disadvantage that the location of the first diffraction order is highly dependent on the wavelengths of the incident light used. This is why the microscope has to be adjusted anew when using different wavelengths. When using microscopes, it is however common practice to make preferred use of the possibility to work with different wavelengths. This however means that it is always necessary to readjust the microscope whenever the wavelengths of the initial illumination are modified. In addition, scanning microscopy usually uses very short laser pulses, which experience a strong spectral diffusion in the first diffraction order. This leads to a negative impact on the results of the spectral analysis of the object.

As described in the U.S. Pat. No. 6,052,216, it has been suggested to modulate the intensity of a laser beam by using a cascade of AOMs. The use of a cascade, that means a line-up of immediate subsequently arranged AOMs, makes it possible to use the light beam of the zero diffraction order each. This is feasible because the technique described modulates the light beam of the zero diffraction order strongly enough to achieve the differences in intensity necessary in microscopy.

This can also be gathered from the U.S. Pat. No. 5,105,304, which suggests to arrange a number of AOMs in a series to control the intensity of the refracted beam of zero diffraction order in a variable way. For the purposes of microscopy this apparatus bears the disadvantage that on the one hand it is necessary to have enough space in order to arrange the cascade and on the other hand each element of the cascade influences the price of the microscope as a negative cost factor.

### SUMMARY OF THE INVENTION

It is the object of the invention to suggest both a microscope equipped with an apparatus meant to weaken the beam and a process to reduce the light beam in a microscope. The microscope described is to be both cost-efficient in terms of production and easy to adjust when using different wavelengths.

According to the invention the above object is achieved apparatus for changing the illumination power in a microscope which comprises:

a light source producing a light beam which defines a beam path in the microscope;

a plurality of other components; and

an acusto optical modulator in the beam path as a single element which influences the illumination power, wherein the acusto optical modulator is arranged such that a light beam of zero diffraction order emanating from the accusto optical modulator, is immediately directed to other components of the microscope.

Additionally the above object is accomplished by a process which comprises the steps of:

providing a light beam emanating from a light source of the microscope and thereby defining a beam path;

providing an acusto optical modulator in the beam path, wherein the acusto optical modulator is a single element which influences the power light beam;

diffracting with the acusto optical modulator an incident light beam into a light beam of zero diffraction order and into light beams of higher diffraction order; and

directing the diffracted light beam of zero diffraction order essentially without any additional weakening of the power to other components of the microscope.

Further advantages and advantageous embodiments of the inventions are subject to subordinate claims.

According to the invention, the microscope is meant to be equipped with an acusto optical modulator in order to be able to modulate both the illumination coming form the light source and especially the illumination emanating form the laser. In doing so, a grating is produced in the acusto opitcal modulator by generating a sound wave preferably as a standing wave, which is running through a crystal. This grating diffracts the incident laser light. The intensity of the impinging illumination power can be modulated by the means of the diffraction. The intensity of light beam diffracted to the first or higher order depends on the amplitude of the sound field that is applied to the crystal or to a high frequency wave applied to the crystal. This is why it is possible to modulate the intensity of the incident light by changing the sound field or the high frequency wave respectively. This effects also the zero diffraction order. When using microscopes, especially scanning microscopes, we discovered to our surprise that a single acusto optical modulator ensures a sufficient modulation of the intensity necessary for the purposes of microscopy, even when using the zero diffraction order.

For the use of the acusto optical modulator in a microscope it is therefore necessary that the exclusively used acusto optical modulator, which is already sufficient for the variation of laser beams, is arranged in the microscope in such a way that the exiting and subsequently used illumination in the microscope matches the diffracted beam of zero diffraction order. This beam is then directly led to further components of the microscope. When choosing suitable modulators, one needs to pay attention to the fact that only those acusto optical modulators are used, which ensure to lower the maximum transmission in the zero diffraction order of about 95% of the incident intensity illumination to such a degree that the extinction of the light illumination is achieved. This extinction is necessary to fade out the light of the illumination laser by a line return during the scan of an image. Basically a remaining transmission by the acusto optical modulator of less than 2% is sufficient for the above procedure. This transmission can already be achieved with the help of a single suitable acusto optical modulator.

As mentioned before, the intensity of the light quantity of zero diffraction order transmitted by the acusto optical modulator can be modified by the amplitude of the applied sound field or the applied high frequency radiation respectively. However, the refracting angle of the first diffraction order depends on the frequency of the sound filed or the applied high frequency. In case only the zero diffraction order is to be of further use in the microscope, then it is necessary to fade out the first and any higher diffraction orders. This can be achieved by using simply a beam limiting device, such as a pinhole diaphragm or a slit. The diameter of the pinhole diaphragm is selected in such a way that at least the first diffraction order of the wavelength with the smallest refraction angle is still faded out.

Contrary to common practice the light beam is not focussed on the AOM crystal when using an especially preferred embodiment. This bears the advantage that one can leave out a focusing optic. This means that the diameter of the beam is wider than the sound field, so that the overlapping part of the light beam always passes the modulator, which, however can be corrected in a simple way with the help of a slit or a slit diaphragm, for example. On the whole, the dynamics are increased whereas the loss of about 3% is so low that it can be neglected.

The apparatus and the method referred to in the invention bear the advantage that a specific variation of the illumination power of a laser is possible by means of a single acusto optical modulator by making use of the zero diffraction order. The use of the zero diffraction order entails the fact that the direction of the beam remains the same apart from a parallel offset for all the wavelengths used. This means that adjusting the microscope is very simple. In addition the single acusto optical modulator, which can be used for the variable modulation of the intensity of the impinging illumination, can be designed as a small component part, while possibly forgoing the high voltage necessary for the functioning of the component part.

Further advantageous embodiments of the invention are shown in the drawing and described in the specification below. With respect to the vividness a disclosure in true scale was not used.

### BRIEF DESCRIPTION OF THE DRAWINGS

The drawing shows in particular:

FIG. 1: the basic set-up of the scanning microscope;

FIG. 2: the basic arrangement of a modulator according to the invention;

FIG. 3: a schematic representation of the working principle of thean acusto optical modulator according to the invention and

FIG. 4: an other schematic illustration of the working principle of an apparatus for changing the illumination power.

### DETAILED DESCRIPTION OF THE INVENTION

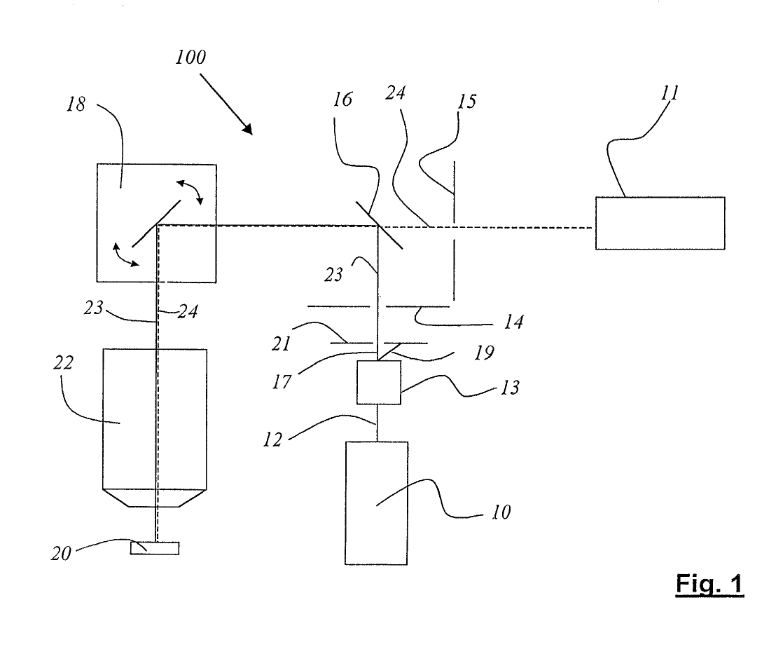

FIG. 1 shows the basic set-up of a scanning microscope 100. The set-up comprises mainly of a light source 10, which generates a light beam 12. Light beam 12 hits an apparatus meant to variably change the illumination power, which shows a single acusto optical modulator 13 and a beam absorber 21. A light beam of zero diffraction order 17 exits the modulator. The light beam is then used as an illumination light beam 23 to investigate a sample 20 in the microscope 100. The beam absorber 21 fades out the light beam of the first diffraction order 19 and light beams of higher diffraction orders. The illumination light beam 23 reaches a main beam splitter 16 via an illumination pinhole. The modulated light of the light source 10 reaches a scanner 18 via the main beam splitter 16. The scanner 18 is equipped in such a way that the sample 20 to be investigated can be scanned by means of the illumination light beam 23 in the way desired. The illumination light beam 23 is directed towards the sample 20 to be investigated via an objective 22. In the same manner a detection light beam 24, which is reflected by the sample 20, is directed towards the scanner 18 via the objective 22. Starting from the scanner 18 the detection light beam 24 moves through the main beam splitter 16. A detection pinhole 15 is provided in front of a detector 11, which is located behind the main beam splitter 16 in the detection light beam 24. In the illustration the detection light beam 24 is shown as a dotted line.

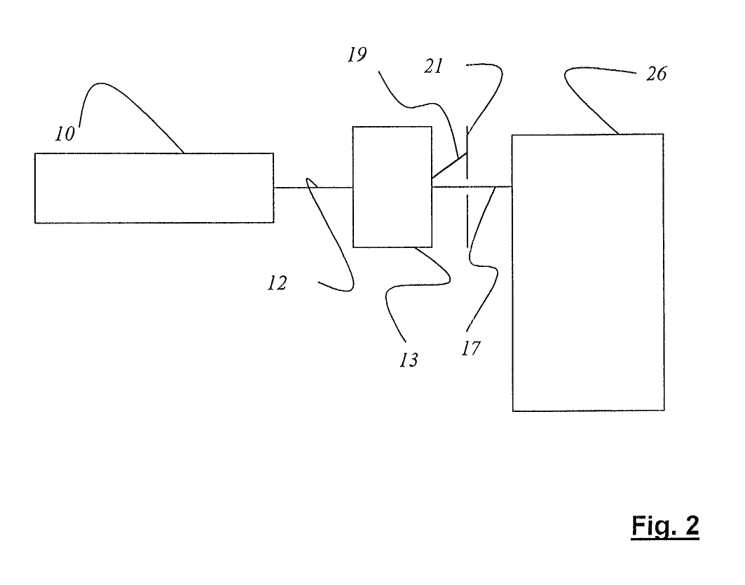

FIG. 2 is an enlarged basic depiction of the modulator 13 used in the beam path according to the invention. The modulator 13 is described as an acusto optical modulator, which is installed behind a light source 10, especially behind a laser light source. Light beam 12 emanates from the light source 10. The light beam 12 is incident on the acusto optical modulator 13 and is diffracted there. Due to this diffraction a light beam of zero diffraction order 17 as well as a light beam of first diffraction order 19 is able to exit the acusto optical modulator. With the help of a beam absorber 21 only the illumination that is not to be further used in the microscope is faded out. According to the invention solely the zero diffraction order 17 is to be further used in the microscope. This is why only the light beam of zero diffraction order 17 is let through the beam absorber 21. At the same time the remaining illumination, especially the light beam of first diffraction order 19, is faded out via the beam absorber 21. The light beam of zero diffraction order 17 is used to investigate samples in the microscope, whilst the remaining components of the microscope are shown schematically in component 26. The beam absorber 21, which acts as a beam limiting medium, is chosen in such a way that only the light beam of zero diffraction order is able to pass through its hole. On the other hand, the light beam of first diffraction order 19 as well as light beams of higher diffraction orders are absorbed for all wavelengths of light beam 12. When designing the beam absorber 21, it goes without saying that generally used pinhole forms especially circular symmetric pinholes or splits can be utilized.

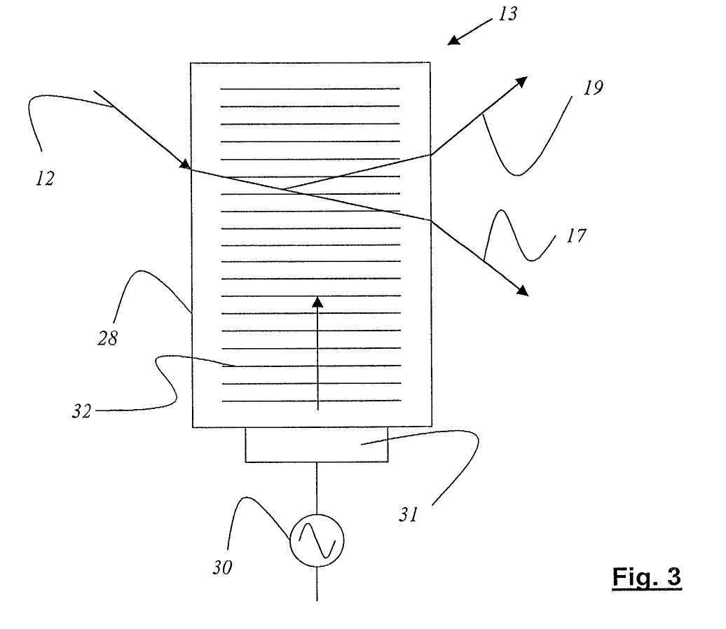

FIG. 3 illustrates in detail how as per the invention the apparatus designed for changing the illumination power of light with one single acusto optical modulator 13 works. The acusto optical modulator 13 uses a crystal that is transparent to laser beams as an acusto optical medium 28. The crystal is transparent to UV rays, when utilizing UV rays as the light beam 12. The crystal can be a TeO₂ crystal, for example, when working with short infrared wavelengths of about 700 to 1.100 nm. In any case, when choosing an acusto optical crystal it is important to make sure that the highest possible maximum transmission of laser power of zero diffraction order can be achieved. In case of the TeO₂ crystal for example, the maximum transmission power ranges between 700 and 1.100 nm i.e. about 95% of the intensity of the incident light beam 12. With the help of a high frequency generator 30 a high frequency signal is applied to the acusto optical modulator. The signal is transmitted to the acusto optical medium 28 by converter 31. As a consequence inside the crystal a sound field is generated that acts as a grating 32 for the incident light beam 12. The grating diffracts the incident light beam 12 with FIG. 3 illustrating the result of the diffraction. The result shows the light beam of zero diffraction order 17 as well as the light beam of first diffraction order 19. When choosing a suitable acusto optical modulator crystal it is important to make sure that the highest possible extinction of the zero diffraction order is achieved. When using a TeO₂ crystal, it is possible to achieve an extinction ratio of 70:1. This ratio corresponds to a remaining transmission of about 1,4% of the intensity of the incident light beam 12. The remaining transmission is sufficient to ensure that in the emanating light beam of zero diffraction order 17 the illumination light beam 23 in the microscope is sufficiently faded out to weaken the power of the illumination light beam 23 during the line return movement of an image scan in order to avoid that the sample is bleached or unintentionally warmed up.

Adjusting the apparatus is simple since the refraction to the zero diffraction order is independent of the wavelength and since the direction of the beam of the incident light beam 12 remains the same for the light beam of zero diffraction order 17 apart from a parallel set piece.

Using a light beam of zero diffraction order 17 in the microscope bears the advantage that is does not depend on wavelengths and therefore does not have the undesired broadening effect of short laser impulses.

When choosing a suitable acusto optcal crystal 28 it is important to ensure that the crystal is able to transmit the highest laser power possible in the zero diffraction order and that the highest possible extinction can be achieved when using the acusto optical modulator 13. To do so, the TeO₂ crystal, for example, can be used in the wavelength range of 700 to 1100 nm, The crystal shows a diffraction index of about 2.2 and it operates at a 5 W/mm² so that no thermal effects influence the operation negatively.

The modular crystal used can also be characterized via some of its characteristics, which are defined in the first diffraction order. In the first diffraction order the crystal shows an extinction coefficient of 2000/1. The acusto optical efficiency is at 80%. The efficiency is defined as the ratio between the intensity of the light beam of first diffraction order 19 and the intensity of the light beam of zero diffraction order without a high frequency field. To come to these results the prerequisites are using the light beam 12 with a wavelength of 1.064 nm and an applied HF-power of 2 W.

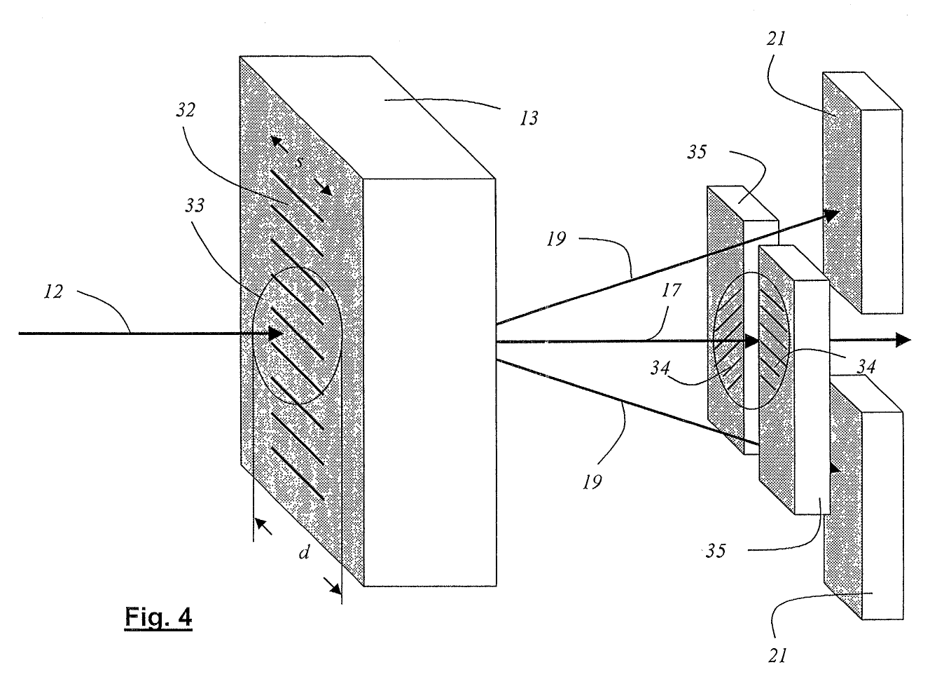

FIG. 4 shows an other schematic illustration of the working principle of an apparatus for changing the illumination power. The incident collimated light beam 12 has a diameter d and a projection size 33 onto the modulator 13. The diameter d is larger as the width s of the acusto optical grating 32. The light of the central region of the light beam 12, which impinges the grating 32, is diffracted in a zero diffraction order and in higher diffraction orders. The parts of the light beam, which do not impinge the grating 32, are passing the modulator 13 undisturbed and impinge the beam absorber 35, which is realized as a slit diaphragm. The light of the higher diffraction orders are absorbed by the further beam absorber 21, which is realized as a slit diaphragm.

The invention was described with respect to a specific embodiment. It is obvious that changes and alterations can be made without leaving the scope of protection of the claims below.

What is claimed is:

1. An apparatus for changing the illumination power in a microscope comprising:
a light source producing a light beam which defines a beam path in the microscope;
a plurality of other components; and
an acusto optical modulator in the beam path as a single element which influences the illumination power, wherein the acusto optical modulator is arranged such that a light beam of zero diffraction order emanating from the accusto optical modulator, is immediately directed to other components of the microscope.

2. Apparatus as defined in claim 1, wherein a beam absorber is used for the selection of the light beam of zero order diffraction order emanating from the acusto optical modulator.

3. Apparatus as defined in claim 2, wherein the beam absorber is in the form of a circular absorber, especially in the form of a pinhole.

4. Apparatus as defined in claim 2, wherein, the beam absorber is in the form slit shaped absorber.

5. Apparatus as defined in claim 1, wherein the acusto optical modulator has an extinction coefficient in the first diffraction order of at least 2000 to 1.

6. Apparatus as defined in claim 1, wherein the acusto-optical modulator is of TeO₂.

7. Apparatus as defined in claim 1, wherein the microscope is a scanning microscope.

8. A process for changing of the illumination power in a microscope comprises the steps of:
providing a light beam emanating from a light source of the microscope and thereby defining a beam path;
providing an acusto optical modulator in the beam path, wherein the acusto optical modulator is a single element which influences the power light beam;
diffracting with the acusto optical modulator an incident light beam into a light beam of zero diffraction order and into light beams of higher diffraction order; and
directing the diffracted light beam of zero diffraction order essentially without any additional weakening of the power to other components of the microscope.

9. Process as defined in claim 8, wherein the light beam of zero order diffraction order is faded out by a beam absorber especially with a pinhole or a circular diaphragm.

10. Process as defined in claim 8, wherein the light beam of zero order diffraction order is faded out by a beam absorber especially with a slit.

11. Process as defined in claim 8 wherein the acusto optical modulator has an extinction coefficient in the first diffraction order of at least 2000 to 1.

12. Process as defined in claim 8 wherein the acusto-optical modulator is made of TeO₂ as an acusto optical medium.

13. Process as defined in claim 8 wherein the microscope is a scanning microscope.
